(19) United States
(12) Patent Application Publication
(10) Pub. No.: US 2010/0015397 A1
(43) Pub. Date: Jan. 21, 2010

(54) METHOD AND TOOL FOR PATTERNING THIN FILMS ON MOVING SUBSTRATES

(75) Inventor: Richard Allott, Tilbrook (GB)

Correspondence Address: PEARNE & GORDON LLP, 1801 EAST 9TH STREET, SUITE 1200, CLEVELAND, OH, 44114-3108, US

(73) Assignee: OERLIKON BALZERS COATING (UK) LIMITED, Tilbrook, Milton Keynes (GB)

(21) Appl. No.: 12/301,257

(22) PCT Filed: May 15, 2007
(86) PCT No.: PCT/GB2007/001811

§ 371 Date: Jul. 31, 2009

(30) Foreign Application Priority Data
May 19, 2006 (GB) 0609987.3

(51) Int. Cl. B29C 35/08; B32B 3/00

(52) U.S. Cl. 428/156; 264/400; 425/174.4

(57) ABSTRACT

A method for forming a regularly repeating pattern in a thin film on a substrate by ablating it directly with radiation form a pulsed laser beam characterised in that the radiation beam is caused to pass through a suitable mask delineating the pattern, the image of the mask pattern being de-magnified onto the surface of the film by a suitable projection lens so that the energy density at the film is sufficiently high so as to cause the film to be removed directly by ablation, the imprinting steps being carried out: in a repetitive series of discrete laser ablation steps using a mask that is stationary with respect to the projection lens and represents only a small area of the total area of the substrate and using a single short pulse of radiation at each step to illuminate the mask, the radiation pulse having such an energy density at the substrate that it is above the threshold value for ablation of the film; and the series of discrete laser ablation steps being repeated over the full area of the surface of a substrate, to give a full pattern comprising a plurality of pixels, by moving the laser beam or substrate in a direction parallel to one axis of the pattern to be formed on the substrate and activating the pulsed laser mask illumination light source at the instant that the substrate or beam has moved over a distance equivalent to a complete number of periods of the repeating pattern on the substrate.

### TECHNICAL FIELD

This invention relates to a laser ablation method and a tool. It is particularly concerned with the field of laser ablation for the processing of thin films on large area glass substrates used in the manufacture of flat panel displays. The invention is novel in that it uses only small masks to ablate the full area of even the largest display and operates on substrates that are in motion.

### BACKGROUND ART

The manufacture of the component parts of flat panel displays (FPDs') requires multiple process steps which include autographic pattern transfer from a mask to form an image in a suitable photosensitive resist layer which is then used to define a pattern in a film below the resist during a subsequent etching process.

To create high resolution patterns it is generally necessary to use an optical projection system where the mask pattern is imaged onto the resist surface using a suitable projection lens. Such systems usually use lamps operating in the ultra violet region as a source of radiation to illuminate the mask and expose the resist layer. The radiation intensity at the resist surface is low so that to achieve the required resist exposure dose means that exposure times up to several seconds are required. During the exposure period it is necessary that the mask and substrate are maintained in exactly the correct relative positions, to ensure good image fidelity. This is achieved either by maintaining both mask and substrate stationary in a so called step and repeat mode or by moving both mask and substrate simultaneously in such a way that the mask and substrate patterns are maintained in register in a so called scanning mode of exposure.

If the lamp source used to illuminate the mask is replaced with a laser source that emits short pulses of radiation, the intensity of radiation at the substrate surface can exceed the threshold for ablation and the substrate material can be directly removed without use of resist and any etching process.

Such laser ablation tools are widely used for directly structuring films over small areas but up to now have not been widely used for the direct patterning of large area substrates as found in the manufacture of ‘FPD’s. The reason for this is associated with the size of the masks required to project an image onto a substrate for an FPD device. Most scanning lithography tools used in FPD manufacturing use 1× magnification projection systems where the mask is the same size as the image to be formed. This is because using a 1× mask allows simple co-ordination of the mask and substrate motions. In this case, to achieve direct ablation at the substrate means that the mask is subjected to an energy density that causes it to be damaged. Only by using a de-magnifying projection optical system with typically a 2 times or higher de-magnification factor can standard chrome on quartz masks be used safely for direct ablation. An optical projection system that de-magnifies the mask pattern means that the mask size has to be greater than the image size so the problem of mask size for moving ablation tools for large FPD substrates becomes even more difficult.

The present invention seeks to overcome the problems and high costs associated with scanning ablation tools for processing large area substrates. It describes a laser ablation process and laser ablation tool using a de-magnifying optical projection system with a small stationary mask that can be used to create a complex repeating pattern on the surface of a large substrate that is moving. The invention is particularly appropriate for FPD device manufacturing.

### DISCLOSURE OF INVENTION

According to a first aspect of the present invention there is provided a method for forming a regularly repeating pattern in a thin film (2) on a substrate (1, 5) by ablating it directly with radiation from a pulsed laser beam (3, 10) characterised in that the radiation beam (3, 10) is caused to pass through a suitable mask (7) delineating the pattern, the image of the mask pattern being de-magnified onto the surface of the film (2) by a suitable projection lens (8) so that the energy density at the film is sufficiently high so as to cause the film (2) to be removed directly by ablation, the imprinting steps being carried out:
(i) in a repetitive series of discrete laser ablation steps using a mask (7) that is stationary with respect to the projection lens (8) and represents only a small area of the total area of the substrate (1, 5) and using a single short pulse of radiation (3) at each step to illuminate the mask (7), the radiation pulse having such an energy density at the substrate (1, 5) that it is above the threshold value for ablation of the film (2); and
(ii) the series of discrete laser ablation steps bang repeated over the full area of the surface of a substrate (1), to give a full pattern comprising a plurality of pixels, by moving the laser beam (3, 10) or substrate (1, 5) in a direction (X1) parallel to one axis of the pattern to be formed on the substrate and activating the pulsed laser mask illumination light source at the instant that the substrate (1, 5) or beam (3, 10) has moved over a distance equivalent to a complete number of periods of the repeating pattern on the substrate (1, 5).

According to a first preferred version of the first aspect of the present invention the method is characterised in that during the imprinting stage the size of the illuminated area at the substrate in the direction (X1) parallel to the direction in which the substrate (1, 5) or beam (3, 10) is moving is sufficient to provide that, after passage of the substrate under the illuminated area, each part of the film has received a sufficient number of pulses of radiation to fully ablate it.

According to a second preferred version of the first aspect of the present invention or of the first preferred version thereof the method is characterised in that the imprinting stage makes use of an optical projection system (8) to transfer the mask pattern on to the substrate (1, 5).

According to a third preferred version of the first aspect of the present invention or of any preceding preferred version thereof the method is characterised in that the source of the pulsed laser beam is an UV excimer laser.

According to a fourth preferred version of the first aspect of the present invention or of the first or second preferred versions thereof the method is characterised in that the source of the pulsed laser beam is an IR solid state laser.

According to a fifth preferred version of the first aspect of the present invention or of any preceding preferred version thereof the method is characterised in that during the imprinting stage an edge of the area to be al dated on the substrate (1, 5) is defined by means of moveable blades (11) located close (9) to the surface of the mask (7).

According to a sixth preferred version of the first aspect of the present invention or of any preceding preferred version thereof the method is characterised in that the mask (7) is caused to move at an appropriate time during or after the moving laser ablation process to allow non-repeating border regions of the pattern to be imprinted on the substrate (1, 5).

According to a seventh preferred version of the first aspect of the present invention or of any preceding preferred version thereof the method is characterised in that the substrate (1, 5) is ablated in a series of parallel bands and the dose of illuminating radiation at the regions where the bands overlap is controlled by using an image forming mask that has a stepped or randomised transmission profile at each side of the mask pattern, the steps or random features corresponding to one or more complete cells in the FPD array.

According to a second aspect of the present invention there is provided a laser ablation tool characterised in that it is adapted to carry out the method of the first aspect or of any preferred version thereof.

According to a third aspect of the present invention there is provided a product characterised by being formed by means of a method of the first aspect or of any preferred version thereof.

The present invention relates to a novel optical projection method for ablating thin films to create high resolution, dense, regularly repeating patterns over large area FPD's using only small masks. The optical system is generally similar to that found in laser ablation tools in that the image is of a reduced size compared to the mask. The invention relies on the use of a pulsed light source such as a UV excimer laser or IR solid state laser to create the film ablating radiation. In the regularly repeating pattern case the mask remains stationary with respect to the projection lens during the laser ablation process while the film coated FPD substrate is moving continuously in the image plane of the projection lens or the image is moved across the surface of the substrate by means of a beam scanner system used in conjunction with a special scanning and imaging projection lens. In the case where unique (non-repeating) patterns are required to be formed in areas adjacent to the repeating pattern the mask may then contain these patterns around the repeating pattern mask area and be caused to move in such a way as to introduce the non repeating pattern area into the beam at a suitable instant during or after the movement of the FPD substrate.

The key to the successful implementation of this process is that the pattern to be ablated has a regular pitch in the direction of relative movement of the substrate and image and that the pulsed laser source is activated at exactly the correct time so that the substrate or image moves by a distance exactly equal to (or to multiples of) the pattern pitch in the time between successive laser ablation pulses. We call this process synchronised image scanning (SIS) as the triggering of the light source and hence the creation of the ablation image on the FPD substrate is exactly synchronised with the substrate or beam motion so that successive images are displaced by integral numbers of pitches of the pattern.

Several key conditions are necessary for the SIS laser ablation process to be effective in the creation of patterns suitable for FPD'S. These are listed below.

Firstly the projection lenses used need to have low distortion and adequate resolution and field size. In general the finest patterns needed in FPD's are of a few microns in size so that optical resolutions in the range of 1 to a few microns are required. Such values are readily achieved with lenses presently commonly used for laser ablation particularly in the UV and IR regions. When conventional chrome on quartz masks are used and the energy density at the mask has to be limited to avoid damage to the mask such lenses de-magnify (reduce) the mask pattern onto the FPD with typical demagnification factors in the range 2 to 10. The combination of resolution and wavelength leads to the requirement that the lens numerical aperture (NA) usually needs to be in the range 0.05 to 0.2. Field sizes of such lenses are in the range of 1 mm to several 10 s of mm. Such values are adequate for the SIS laser ablation process discussed here. The lens magnification factor can be any value that is convenient so long as the energy density at the substrate is sufficient to ablate it and the energy density at the mask is insufficient to damage it.

For the case where SIS ablation is performed using an IR solid state laser the lens has to be specially designed so that it can be used for high resolution imaging in conjunction with a beam scanner unit. Such lenses are unusual in that image fidelity needs to be maintained very closely across the fall field of the projection lens.

The lenses used for both UV excimer laser and IR solid state laser SIS ablation are generally designed to be telecentric on the image side. This ensures that the size of the image is maintained constant if the substrate is displaced slightly from the exact image plane along the optical axis.

Secondly it is important that the light source creating the ablating radiation is of a sufficiently short duration. This is important as the substrate to be ablated or the laser beam are moving continuously and the light pulse needs to be sufficiently short to ‘freeze’ its motion so that the image created is not blurred. For substrates or beams moving at speeds up to several meters per second, to limit the image blur to less than 1 micron requires that the pulsed source has a duration of a fraction of a micro second (10⁻⁶ sec). For this reason pulsed lasers make ideal light sources as the pulses emitted are usually well under 1 micro second in duration so that no image blur effects are seen even when the relative speed between the substrate and the image exceeds many meters per second. UV excimer lasers and JR solid state lasers are particularly good light sources as they emit pulses at wavelengths that can readily ablate common films and have convenient repetition rates (few Hz to few 10 s of kHz). This means that FPD's with pattern pitches in the range of a small fraction of a mm (e.g. 50 μm) up to over 1 mm in size can be processed by this SIS laser ablation method at modest beam or stage speeds. As an example, an FPD pattern with a 100 μm pitch in the substrate moving direction can be patterned by an excimer laser firing at 300 Hz forming an image that has a width in the moving direction of 1 mm with the firing synchronised so that the images overlap every second pattern pitch with the substrate moving with respect to the image at a speed of only 60 mm/sec. In this case the image contains 10 repeat patterns in the full beam width so that after the substrate has moved through the full image area each area will have received 5 laser shots. If the film is thin and only one laser shot is needed to remove it fully then in this case the substrate would be moving at a speed of 300 mm per second. If the film is thicker and needs 10 shots to remove it fully the substrate speed is only 10 mm per second. As another example an FPD pattern with a 100 μm pitch in one direction can be patterned by an IR solid state laser firing at 20 kHz forming an image that is moved by a beam scanner system in this direction and has a width in the beam movement direction of 0.6 mm with the laser firing synchronised so that the images overlap every pattern pitch with the beam moving at 2 meters per second. In this case as the image contains 6 repeat patterns within the full width so that after passage of the full beam over the substrate each area will have received 6 laser shots.

The third key requirement for the successful implementation of this SIS laser ablation process is that the laser firing has to be timed exactly with respect to the stage or beam motion. For excimer laser based SIS pattern ablation, where either the image is stationary and the substrate is moved in the image plane of the projection lens or the substrate is stationary and the mask and projection lens are moved with respect to the substrate, this means that the stages need to have high resolution encoders fitted and to be highly repeatable. It also means that fast and jitter free control electronics are needed to generate the laser firing pulses from the stage encoder signals so that small changes in stage speeds (due to servo control loop delays) do not affect the exact positioning of the images. Such electronics are readily available in standard CNC stage control systems. For the case where IR solid state lasers are used and the image is moved across the substrate by means of a beam scanner system the accurate control and synchronisation of the beam scanner system with the laser pulses is critical.

The fourth important condition for successful SIS laser ablation is that the energy density of the radiation created at the image plane by each laser pulse is above the threshold energy density heeded to cause direct ablation of the film.

Hence the envisaged method for best using this SIS laser ablation process with excimer lasers is to create an image of a mask, which is held stationary with respect to the projection lens, at the FPD surface which is then moved under the optical projection system to ablate a band of film across one axis of the FPD. After one band has been ablated the optical system is stepped sideways and another band adjacent to the first ablated. Clearly the sidestep distance has to be an integral number of pattern pitches in the stepping direction so that the 2nd ablated band pattern is exactly registered to the first band, ha general the width of each band ablated should be such that when all scans are complete the full area of the FPD has been ablated. This is desirable but not essential as is discussed later.

It is also possible to perform excimer laser based SIS ablation using different methods for achieving the correct relative motion of the optical system and substrate. In one case the optical system incorporating the projection lens and mask is held stationary at all times and the substrate is moved in 2 orthogonal directions. In another case the substrate is held stationary at all times and the optical mask projection system is able to move in 2 orthogonal directions.

To maximise the speed of the FPD SIS laser ablation process it is necessary to reduce the total number of parallel bands and to move the FPD at the highest possible speed. The former requirement is met by creating an image that is as wide as possible though this is limited by the availability of suitable lenses. The requirement to scan at the highest possible speed is met in the following way.

In general FPD's are rectangular in shape and have approximately square pixels each of which is divided up into at least 3 sub-pixels or cells representing the different colours necessary to form a full colour display. This means that the repeating patterns have different pitches in the 2 different FPD axes. In general the pixels are divided into sub-pixels or cells along the long axis of the FPD so that there are considerably more (x5 or x6) cells in the long axis of the FPD compared to the short axis. The excimer laser SIS laser ablation technique discussed here can be implemented such that the substrate or beam is moved in a direction parallel to either the short or long FPD axes though there is some advantage in moving parallel to the long axis in that the number of passes required to cover the full FPD area is less than when moving parallel to the short axis and hence the number of times the substrate has to be slowed, brought to rest and accelerated in the reverse direction is minimised and the process rate is maximised.

As the excimer laser SIS laser ablation process requires that the FPD and image move relatively to each other by an integral number (1 or more) cells between laser pulses it is possible to increase the relative speed by moving more than 1 cell pitch between laser pulses. Moves of 2, 3 or more can be used to increase speeds. The consequence of increasing the distance moved between ablating pulses is that the ablating beam at the FPD increases in size in the moving direction. As an example consider an FPD with a pixel size of 0.6×0.6 mm. Each pixel is divided into 3 cells each of 0.6×0.2 mm in size. If a laser firing at 300 Hz is used and the FPD or beam is moved in the cell short axis (FPD long axis) direction a speed of 60 mm/sec is achieved if the substrate or beam moves just one cell pitch each laser pulse. By moving 2 cell lengths between laser ablation pulses the speed is increased to 120 mm/sec.

The requirement that each area of the FPD receives a certain number of pulses to fully ablate it means that the size of the beam in the scan direction is given by the product of the cell pitch, the cell number moved between pulses and the number of ablating pulses required by each area. For the example above with a 0.2 mm cell pitch and a movement of 2 cell lengths between pulses if 5 pulses are required to achieve the correct dose in the film then the beam size in the moving direction is 2 mm.

The envisaged method for best using this SIS laser ablation process with JR solid state lasers is to create an image of a stationary mask at the FPD surface that is moved by means of a beam scanner system to ablate a row of pixels across a narrow band of film parallel to one axis of the FPD. After one row of pixels has been patterned the beam scanner reverses the direction in which the beam is moving to ablate an adjacent parallel row. This backwards and forwards moving process repeats and at the same time the substrate is moved continuously in the direction perpendicular to the beam scan direction. By this means a continuous band parallel to the substrate moving direction is patterned. We call this beam scanning in conjunction with substrate motion to process a band of repeating structures “Bow Tie Scanning (BTS)”. After one band has been ablated the optical system incorporating mask, scanner unit and projection lens is stepped sideways and another band adjacent to the first ablated. Clearly the sidestep distance has to be an integral number of pattern pitches in the stepping direction so that the 2nd ablated band pattern is exactly registered to the first band. In general the width of each band ablated should be such that when all bands are complete the full area of the FPD has been ablated. This is desirable but not essential as is discussed later.

It is also possible to perform IR solid state laser based SIS ablation using different methods for achieving the correct relative motion of the optical system and substrate. In one case the optical system incorporating the projection lens, beam scanner unit and mask is held stationary at all times and the substrate is moved in 2 orthogonal directions. In another case the substrate is held stationary at all times and the optical mask projection and scanner system is able to move in 2 orthogonal directions.

When ablating films in bands by either UV excimer lasers or IR solid state lasers using SIS and BTS techniques great care has to be taken to ensure that no discontinuities exist at the boundary between bands. Such band boundary discontinuities are sometimes referred to as ‘stitching errors’ or stitching Mura effects. One way to avoid these band boundary Mura effects utilizes the fact that the image area imprinted on the film surface at each laser shot consists of a 2D pattern of repeating identical cells and that the 2 side edges of the pattern imprinted can be formed to create a stepped cell structure or even have isolated cell patterns. These structures can be shaped such that the side edge of one band exactly interleaves at the scan boundary with the side edge of the adjacent band so that all cells receive the same number of laser shots and the line mat joins any two adjacent bands is no longer exactly straight. This technique can be applied to either UV excimer laser SIS ablation or to IR solid state laser SIS ablation.

For the case of UV excimer laser SIS ablation a typical image imprinted on the surface of the film could be 100-200 pixels long in the direction perpendicular to the moving direction and many tens of pixels long in the direction parallel to the moving direction. The multiplicity of cells in the direction parallel to the moving direction allows the possibility of forming a staircase of cells or more complex pattern with isolated cells at the side edges of the pattern to give a staircase or non-straightness to the beam edge. Many stepped or isolated cell patterns are possible so long as both ends of each image are symmetrically patterned in a way that ensures all cells within the band and in the overlap region between bands are subjected to the same number of laser shots.

For the case of BR solid state laser SIS ablation a typical image imprinted on the surface of the film is much smaller but can still contain multiple cells. As an example for a laser ablation process that needs 5 laser shots on each area of the substrate to ablate the film fully the image would be 5 cells long in the direction parallel to the moving direction and a similar number in the direction perpendicular to the moving direction. The multiplicity of cells in the direction perpendicular to the moving direction allows the possibility of forming a staircase of cells or more complex pattern with isolated cells at the side edges of the image to give a staircase or non-straightness to the beam edge. Many stepped or isolated cell patterns are possible so long as both sides of each image are symmetrically patterned in a way that ensures all cells within the scan band and in the overlap region between bands are subjected to the same number of laser shots.

For the case of UV excimer laser SIS ablation, control of the number of laser shots each area of the substrate receives right up to the 2 boundaries of the FPD device in the scan direction is an important issue. This is a potential problem with this SIS laser ablation process as the beam width in the scan direction is such that many patterns are ablated on each laser pulse. If multiple laser pulses are required on each area then the substrate or beam moves only a fraction of the image width between laser pulses and if the triggering of the ablating laser is suddenly stopped at the boundary of the FPD there will be an area extending over part of the image where the number of shots delivered to each area is incomplete. Depending on the number of shots needed on each area this partially ablated band will be up to almost the full width of the image in the scan direction and the number of laser ablation shots received by each area over this distance will change from one to the maximum value. Clearly this is highly undesirable so that a method is needed to prevent this

The same problem exists at the sides of the FPD if the edge of the beam used is stepped or discontinuous to control Mura effects at the band boundary regions. At the outer edges of the extreme bands used to ablate the FPD a partially ablated region with width equal to the width of the structured region on the ends of the beam will be created. In this region the number of laser shots received by each area will fall from the full value to one. Clearly this is highly undesirable so that a method is needed to control it.

Both of the edge problems described are solved by the same method, which involves the use of blades positioned close to the mask that move into the beam to obscure the image in the boundary regions. The blades are motor driven and controlled from the stage control system so can be driven, into the beam at the correct time during the process. The blades are oriented with their flat faces parallel to the surface of the mask, and are located very close to the mask surface such that the blade edge is accurately imaged on to the substrate surface. Four blades are required in total, one to deal with each of the four substrate boundaries. In practice blades are sensibly mounted in pairs on a two axis CNC stage system and are designed so that the blade edges are exactly parallel to the FPD (and mask) pattern.

To solve the moving direction edge problem a blade is moved into the beam at the mask to reduce the beam width progressively as the FDP boundary is approached. This means that the motion of the blade has to be accurately synchronized in position to the motion of the main FPD stage. This is exactly the method used in standard lithographic exposure tools to link the mask stage to the wafer stage so is readily implemented in the control system. The blade clearly has to move a distance and at a speed that is related to the main stage speed by the lens magnification.

Side boundary blades are used to eliminate the narrow incompletely ablated bands at each side edge of the FPD and can also be used to control the overall width of the area ablated on the FPD surface. It is possible to set the width of each band such when all bands have been completed the width of the FPD device has been covered exactly. Such an arrangement maximises the process rate but is complex to set up. In practice it is preferable to work with bands that are a very small amount (e.g. 1 cell width) wider than the size that fits exactly into the full FPD width. In this case the beam obscuring blades used to obscure the incompletely ablated bands on each outer side of the outer bands are then advanced further into the beam to ‘trim’ the outer bands to the required width to create an FPD of exactly the correct size.

For the case of IR solid state laser SIS ablation using BTS mode processing the beam is scanned in the direction perpendicular to the direction of relative movement of the substrate and optical system to create a patterned band on the FPD and hence there is generally not an edge issue at the beginning or end of each band as the moving image on the FPD surface moves parallel to the end of each band. There may however be an issue about forming exactly the correct number of pixels along the length of the band since the finite number of pixels in the image in the direction perpendicular to the beam moving direction may not divide exactly into the number of pixels required by the FPD design. If this is the case then the final scan of the beam across each band is adjusted in position along the band by adjustment of the beam scanner controls such that the exact number of pixels along, the length of the band is created. Such a procedure leads to some of the lines of cells in the last scan of the beam across the band receiving twice the number of laser shots compared to the rest of the band but since this process is generally used to clear a thin film of material from a lower substrate an excess of laser shots is not usually a problem.

In SIS ablation using BTS mode processing with an IR solid state laser the join line between adjacent bands must be controlled so that all cells in the boundary region receive the same number of laser shots. This is achieved by careful overlap of the last image laid down by a beam scan in one band with the first image laid down by a corresponding beam scan in the adjacent band. As an example in the case where the moving image contains an array of 4 cells in the scanning direction and 4 cells in the perpendicular direction (16 cells in total) and the beam scanning speed and laser firing rate are adjusted so that the laser fires each cell pitch in the scanning direction then in the main part of each scanned line each part of the substrate will receive a total of 4 laser shots but when the laser ceases to fire at the end of the scanned line the last image will contain cells that are incompletely ablated as they contain progressively less than the full number of laser shots. In the case given here the last image contains columns that are 4 cells wide where the number of shots per unit area reduces from 4 to 3 to 2 to 1 across the image. Full ablation of this incompletely ablated region at each band edge is achieved by overlapping it with the corresponding incompletely ablated region on the adjacent band. In the case given here this means that the images on adjacent bands are caused to overlap by 3 cells so that the cells that received only 3 shots in one band receive an additional single shot from the adjacent band, the cells that received only 2 shots in one band receive an additional 2 shots from the adjacent band and the cells that received only 1 shot in one band receive an additional 3 shots from the adjacent band. In such a way the band boundaries are merged together to form a continuous pattern where all cells receive exactly the same number of laser shots.

This process is effective for all the boundaries between bands in the body of the FPD but it is clear there is still a problem with incompletely ablated cells at the outer edges of the first and last bands. If the requirement exists to clear all cells completely at these side edges men this is achieved by carrying out an additional process step where a narrow band at each side edge of the FPD is patterned with the same area scanned multiple times and the extreme cell position corresponding to the very outermost edge of the FPD cell pattern so that these outermost cells receive the correct number of laser shots. In the case discussed above with a beam containing an array of 4 by 4 cells in order to cause the extreme outermost cell to be subjected to 4 laser shots during this subsidiary process the beam has to scan up to this cell a further 3 times to completely ablate it. This solves the problem of incomplete ablation at the extreme sides of the FPD but in the process causes a band of cells to receive many more laser shots than the minimum needed for full ablation. For the case considered here over the width of the narrow band that is processed in order to clear each side edge cells receive as many as 16 shots where 4 shots are applied during the standard band pattern process and the further 12 shots are imparted during the 3 extra scans needed to apply 4 shots to the extreme edge cells.

All of the above discussions relate to the case where the pattern to be imprinted is repeating in a regular way over the full area. There may however be cases where special non repeating patterns occur immediately adjacent to the repeating area. Examples of this would be the complete removal of a BM resin film in a border area a few mm wide around the edge of the BM matrix on an LCD colour filter assembly, the removal of the TTO layer from border regions of an LCD colour filter assembly that correspond to the positions of driver chips in the assembled module or the farming of alignment and reference marks around the edge of the FPD pixel matrix. In these cases it is necessary to incorporate these non regular features adjacent to the regular ones on the mask and mount the mask on a stage system of some type so that these non regular features can be moved into the beam and hence transferred to the substrate as the moving laser ablation process proceeds to the edges of the FPD device.

When using UV excimer laser SIS processing one method of readily ablating these non-repeating areas is to imprint them in a step and repeat process mode where the mask and substrate are both stationary during each laser ablation process. In this case the edge features can be incorporated into the mask at known positions and the mask is mounted on a 2 axis stage system so that the appropriate areas on the mask can be moved into the beam at the same time that the substrate or optical system is moved to the corresponding position on the FPD so that the correct edge feature is imprinted at exactly the correct position on the substrate. Such a process is effective but can be slow as several separate steps are required and hence the overall time to ablate the full FPD area is extended.

In some excimer laser cases a much faster method can be used to ablate these edge features. This method requires both mask and substrate to be in relative motion with respect to the projection lens. In this case the edge feature patterns have to be situated on the mask immediately adjacent to the regular feature pattern and the mask and substrate have to move exactly together in exact register at relative speeds set by the lens magnification. This is the type of moving process used in advanced high throughput IC semiconductor exposure tools and 1×FPD exposure tools. Of course if the mask has to be moved during the laser ablation process then its movement (and that of the substrate) has to always obey the requirement that it is in the correct position when the laser is fired to overlay the regular substrate FPD pattern correctly. Since the substrate and its associated chuck and stages are massive and hence cannot change speed rapidly it is important that the mask and associated stages are able to accelerate rapidly to an appropriate speed.

Since the non repeating features always occur around the edge of the regular pattern on the FPD, the substrate stage is generally in the process of slowing at the end of its pass across the FPD in order to turn around and reverse direction. Hence the substrate is likely to be moving slowly at the time the mask stage needs to move and hence the speed that the mask needs to achieve in order to become synchronised with the substrate stage is modest.

For SIS ablative processing with an IR solid state laser the repetition rate of the laser and speed of the beam are too high to allow movement of the mask while the laser is firing. In this case in order to create special non repeating features around the main repeating FPD structure appropriate masks are moved info the beam to form a small suitably shaped image on the FPD surface and the beam is then moved over the surface of the FPD using the beam scanner controls and the stage motion if required to ablatively clear the film from the desired areas. Such a 2D scanning process is very well known in the areas of laser marking and engraving systems.

The radiation used for illuminating the mask on an SIS laser ablation tool can be from a range of sources. The primary requirements are that the wavelength of the radiation is such that it is absorbed sufficiently by the film to ablate it effectively and that the sources must emit pulses that are sufficiently short to avoid image blur on moving substrates.

Examples of possible laser sources that can be used with this invention are the following:
a) Exdmer lasers operating at 248 nm, 308 nm or 351 nm
b) Diode or lamp pumped solid state lasers based on Neodymium as the active medium operating at 1064 nm, 532 nm, 355 nm or 266 nm.
c) Any other pulsed laser source that emits radiation in pulses of duration less than one microsecond at a wavelength that is absorbed by the film that is required to be ablated.

Clearly in all cases optical systems have to be used to create a uniform radiation field at the mask to ensure a uniform laser ablation dose at the film within the image area.

### DESCRIPTION OF DRAWINGS

Exemplary embodiments of SIS laser ablation tool architectures will now be briefly discussed with reference to the accompanying diagrams; FIGS. 1, 2, 3, 4 and 5.

FIG. 1

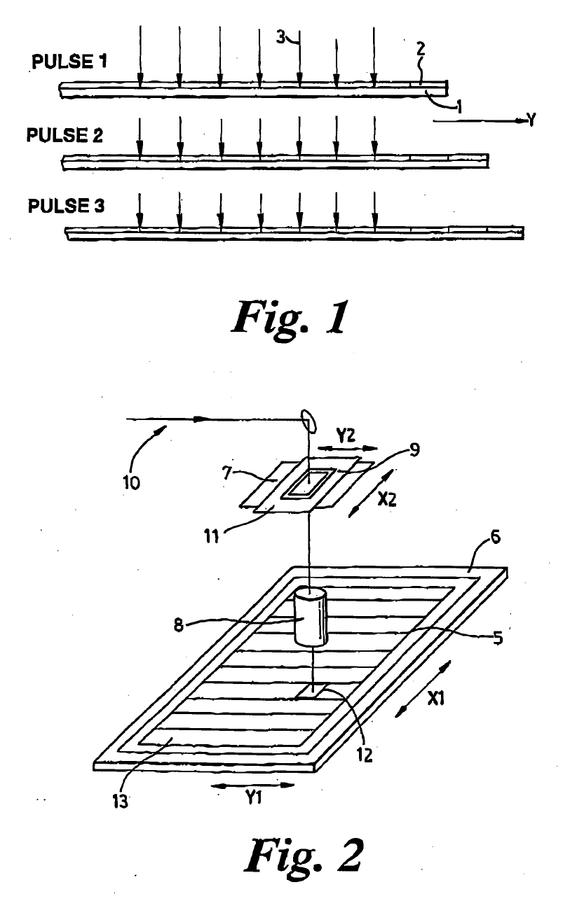

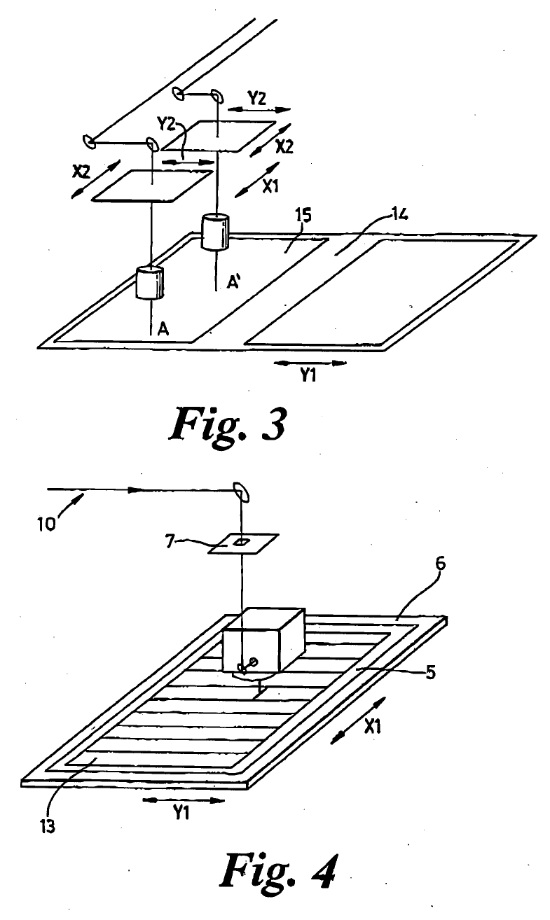

This shows the principle of the SIS laser ablation method. A substrate 1 coated with a film layer 2 is moved progressively with respect to the ablating pulsed radiation beam 3 in direction Y. The beam creates an image on the film that corresponds to the required pixel or cell pattern of the FPD. In the figure the image is shown to contain 6 pixel cells in the direction in which the substrate is moving. Each pulse of radiation hence ablates a band of film that is 6 cells wide. Between laser pulses the substrate moves exactly 1 cell pitch so that the next pulse creates a pattern that exactly overlaps the first but is displaced by 1 cell pitch. In the figure shown where the beam is 6 cells wide each area of film receives 6 pulses of radiation and then moves from the beam.

FIG. 2

This shows a possible geometry for an excimer laser SIS projection ablation tool. A glass substrate 5, coated with the component films of an LCD colour filter or TFT array and over coated with a thin indium-tin oxide (TTO) layer, is supported on a two-axis table 6 able to move in orthogonal X₁ and Y₁ directions. The mask 7 with the pattern to be transferred is mounted in the beam above the projection lens 8. The beam obscuring blades 11 are supported on another two-axis table 9 able to move in orthogonal X₂ and Y₂ directions. The mask may be mounted on a third 2 axis moving stage assembly for the imprinting of non-repeating patterns around the edge of the regularly patterned area if required. The two directions Y₁ and Y₂ (and also X₁ and X₂) of the tables 6, 9 must be set up to be accurately parallel to each other.

A beam 10 from an excimer laser operating at 351 nm, 308 nm, 248 nm or even 193 nm is shaped and processed to create a uniform field at the mask 7. The illuminated area 12 provided by way of the mask 7 is imaged onto the film surface on the substrate 5 using a projection lens 8 with de-magnification factor of (for example) 2.

In operation the system works as follows. The substrate is aligned rotationally and spatially using alignment cameras that are not shown in FIG. 2. The substrate is then moved to one edge and a band of film 13 ablated by movement of the FDP in direction Y₁. Clearly as this is an edge band the structured edge on one side of the image needs to be obscured to prevent partial laser ablation so that the blade with its edge parallel to the Y direction is moved into the beam by moving the blade stage the correct amount in the X direction. At the start and end of each of the Y movements the blades attached to the table 9 progressively move into the beam 10 in direction Y to obscure the beam in a controlled way to define the edge of the ablated band accurately. After completing this band the blade obscuring the image edge structure is removed from the beam and the substrate is stepped sideways (in direction X₁) by some appropriate distance that corresponds to the mean size of the image. Further substrate movements in Y₁ are then repeated. For the last band the appropriate side blade needs to be moved into the beam to obscure the structured image edge. After complete coverage of the substrate the process is completed.

FIG. 2 shows the case where the FPD is moved in the direction parallel to short axis and 10 bands are required to cover the full FDP area. Depending on the display and lens field sizes as well as the moving direction chosen the number of scans may be greater or less than 10. A typical lens field could be up to 50 mm in diameter but smaller is more usual. Allowing for a structured image edge shape means that the side step distance may typically be in the range 20 to 45 mm so that up to 50 or even more bands would be used to cover the full area of a 52″ FPD when moved in the short axis direction whereas only 20 bands might be needed to complete the laser ablation of a 42″ FPD when scanned in the long axis direction.

FIG. 3

This shows another possible laser ablation tool arrangement. Here the substrate stages are much larger so that glass sheets 14 with multiple FPD's can be ablated. Because of the larger size of the substrate it is convenient to restrict the motion of this stage to one axis (Y₁). In this case the motion of the beam with respect to the substrate in the X direction is achieved by mounting the mask and lens assembly on a carriage that moves on a stage in the X direction on a gantry over the substrate. Such an arrangement using split axes is convenient for large substrates as the footprint of the tool is reduced.

FIG. 3 also shows the use of two parallel identical optical projection channels creating two ablating areas (A, A′) on the FPD substrate 15 at the same time. Such an arrangement reduces the total laser ablation time without having to increase stage speed. It is certainly technically possible to have more than two parallel projection channels operating at the same time. If the sheet to be processed is sufficiently large, systems having 8 or even more optics heads fed by either a single laser or multiple lasers can be envisaged. The practical limit is set by the proximity of the masks and blade stages on the optics heads as well as the increasing complexity of the tool.

Different tool architectures to those shown in FIGS. 2 and 3 are also feasible. For the case where the substrate is very large it is possible to maintain it stationary during laser ablation and have the optical mask projection system move in 2 axes. In this case the mask and projection optics are carried on a carriage that can move in two axes on gantries over the top of the substrate.

An alternative arrangement is to operate with the substrate held in the vertical plane. Such an arrangement could apply to both of the architectures shown in FIGS. 2 and 3 but is likely to be more easily realised for the split axis system shown in FIG. 3. In this case the (large) substrate to be ablated would be held on its edge and move horizontally in the Y1 direction while the mask stages move in the parallel Y2 direction. Movement of the laser ablation pattern along the length of each FPD is achieved by stepping the mask carriage vertically in the X1 direction with corresponding mask position correction by movement in the parallel X2 direction.

FIG. 4

This shows an arrangement similar to that shown in FIG. 2 but where a beam scanner unit is included in the optical projection system to allow SIS ablation with the beam from an IR solid state laser 10 to be carried out. In this case the image is moved with respect to the substrate in BTS mode by the beam scanner unit in the X1 direction perpendicular to the direction Y1 in which the substrate is moving and at the end of each band the substrate is stepped sideways in the X1 direction by the width of the band.

As with the excimer laser case other tool geometries are also possible for IR solid state laser SIS ablation. The substrate can remain stationary at all times and the optical system consisting of projection lens, scanner unit and mask moved in two orthogonal axes or alternatively the substrate can move in only one direction and the optical system moves in the other. Vertical orientation of the substrate is also possible.

1. A method for forming a regularly repeating pattern in a thin film (2) on a substrate (1, 5) by ablating it directly with radiation from a pulsed laser beam (3, 10) characterised in that the radiation beam (3, 10) is caused to pass through a suitable mask (7) delineating the pattern, the image of the mask pattern being de-magnified onto the surface of the film (2) by a suitable projection lens (8) so that the energy density at the film is sufficiently high so as to cause the film (2) to be removed directly by ablation, the imprinting steps being carried out
(i) in a repetitive series of discrete laser ablation steps using a mask (7) that is stationary with respect to the projection lens (8) and represents only a small area of the total area of the substrate (1, 5) and using a single short pulse of radiation (3) at each step to illuminate the mask (7), the radiation puke having such an energy density at the substrate (1, 5) that it is above the threshold value for ablation of the film (2); and
(ii) the series of discrete laser ablation steps being repeated over the full area of the surface of a substrate (1), to give a full pattern comprising a plurality of pixels, by moving the laser beam (3, 10) or substrate (1, 5) in a direction (X1) parallel to one axis of the pattern to be formed on the substrate and activating the pulsed laser mask illumination light source at the instant that the substrate (1, 5) or beam (3, 10) has moved over a distance equivalent to a complete number of periods of the repeating pattern on the substrate (1, 5).

2. A method as claimed in claim 1 characterised in that during the imprinting stage the size of the illuminated area at the substrate in the direction (X1) parallel to the direction in which the substrate (1, 5) or beam (3, 10) is moving is sufficient to provide that, after passage of the substrate under the illuminated area, each part of the film has received, a sufficient number of pulses of radiation, to fully ablate it.

3. A method as claimed in any preceding claim characterised in that the imprinting stage makes use of an optical projection system (8) to transfer the mask pattern on to the substrate (1, 5).

4. A method as claimed in any preceding claim characterised in that the source of the pulsed laser beam is an UV excimer laser.

5. A method as claimed in claim 1, claim 2 or claim 3 characterised in that the source of the pulsed laser beam is an IR solid state laser.

6. A method as claimed in any preceding claim characterised in that during the imprinting stage an edge of the area to be ablated on the substrate (1, 5) is defined by means of moveable blades (11) located close (9) to the surface of the mask (7).

7. A method as claimed in any preceding claim characterised in that the mask (7) is caused to move at an appropriate time during or after the moving laser ablation process to allow non-repeating border regions of the pattern to be imprinted on the substrate (1, 5).

8. A method as claimed in any preceding claim characterised in that the substrate (1, 5) is ablated in a series of parallel bands and the dose of illuminating radiation at the regions where the bands overlap is controlled by using an image forming mask that has a stepped or randomised transmission profile at each side of the mask pattern, the steps or random features corresponding to one or more complete cells in the FPD array.

9. A laser ablation tool characterised in that it is adapted to carry out the method of any preceding claim.

10. A product characterised by being formed by means of a method as claimed in any of preceding claims 1 to 8.
